(19) United States
(12) Patent Application Publication
(10) Pub. No.: US 2002/0104901 A1
(43) Pub. Date: Aug. 8, 2002

(54) Fuel injection valve for internal combustion engines

(76) Inventors: Ulrich Kunzi, Winnenden (DE); Katsuoki Itoh, Leonberg (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/018,315

(22) PCT Filed: Apr. 10, 2001
(86) PCT No.: PCT/DE01/01408

(30) Foreign Application Priority Data
Apr. 18, 2000 (DE) 100 19 153.3

(51) Int. Cl. F02M 59/00

(52) U.S. Cl. 239/533.2

(57) ABSTRACT

A fuel injection valve, having a valve body (1) which is axially braced against a valve holding body (3) and in which a bore (5) is embodied that is closed on the end toward the combustion chamber and there has a valve seat (32) and at least one injection opening (34). Disposed in the bore (5) is a pistonlike valve member (10), which is guided in the bore (5) by a first radially widened portion (110) and a second radially widened portion (210). The valve member (10) surrounds a pressure chamber (23), which can be filled with fuel and which continues, toward the valve seat (32), in the form of an annular conduit surrounding the valve member (10). Remote from the combustion chamber, toward the valve member (10), a valve piston (12) is disposed in the bore (5) and seals off the pressure chamber (23) and contacts the valve member (10). The first radially widened portion (110) has a greater play in the bore (5) than the second radially widened portion (210), so that the friction of the valve member (10) in the longitudinal motion is reduced. The first radially widened portion (110) then serves the purpose only of guidance, while the sealing off of the pressure chamber (23) is effected by the valve piston (12) and thus by means of a component that is separate from the valve member (10)

### PRIOR ART

The invention is based on a fuel injection valve for internal combustion engines as generically defined by the preamble to claim 1. One such fuel injection valve is known from German Patent DE 42 05 744 C2. The fuel injection valve has a valve body, with a bore embodied in it that is closed on one end; the closed end is embodied as a valve seat and protrudes into the combustion chamber of the engine. A pistonlike valve member is disposed longitudinally displaceably in the bore and on its end remote from the combustion chamber has a first radially widened portion, with which it is guided sealingly in the bore. On its end toward the combustion chamber, the valve member merges with a valve sealing face, which cooperates with the valve seat for controlling at least one injection opening. Near the valve sealing face, a second radially widened portion is embodied on the valve member, and with it the valve member is guided in the bore.

Between the portion of the bore that guides the first radially widened portion of the valve member and the valve seat, a pressure chamber is formed in the valve body by means of a radially widened portion of the bore; the pressure chamber can be filled with fuel at high pressure, and toward the combustion chamber, it continues in the form of an annular conduit, surrounding the valve member, as far as the injection openings. On the second radially widened portion, recesses are embodied, through which the fuel can flow to the injection openings. By means of the guided second radially widened portion of the valve member, the valve member is guided precisely centrally in the bore, and the fuel inflow from the pressure chamber to the injection openings is symmetrical, so that the fuel—in the event that a plurality of injection openings are provided—is injected uniformly through all the injection openings into the combustion chamber of the engine.

Because of the high pressure in the pressure chamber, despite the slight play of the first radially widened portion of the valve member guided in the bore, there is a resultant flow of fuel and leaking oil out of the pressure chamber through the annular conduit formed between the first radially widened portion and the bore. This leaking oil flow is delivered to a leaking oil chamber and from there on to a leaking oil system.

To achieve good guidance of the valve member and at the same time secure sealing off of the high-pressure region from a leaking oil region of the fuel injection valve, the play of the radially widened portions of the valve member in the bore is embodied as extremely small, usually only a few micrometers. Since from a production standpoint it is extremely difficult to embody both radially widened portions of the valve member exactly in alignment with one another, the disadvantage arises in the known fuel injection valve that because of production variations, seizing and increased friction of the valve member in the bore can occur.

To avoid this problem, it is true that the play of the valve member can be increased at one of the two radially widened portions, but that is disadvantageous in both cases: If the sealing radially widened portion remote from the combustion chamber is given increased play, the result is an excessive leaking oil flow from the pressure chamber of the fuel injection valve into the leaking oil chamber; on the other hand, if the play of the second radially widened portion near the valve seat is increased, the result is imprecisions in the location of the valve sealing face relative to the valve seat and thus the problems that are supposed to have been avoided with the second guide.

### ADVANTAGES OF THE INVENTION

The fuel injection valve of the invention having the characteristics of the body of claim 1 has the advantage over the prior art that the first radially widened portion of the valve member, remote from the combustion chamber, can be equipped with a greater play in the bore, so that seizing or increased friction of the valve member in the bore is avoided without creating an increased leaking oil flow. The sealing off of the pressure chamber is accomplished by an additional valve piston, which is guided remote from the combustion chamber toward the valve member in the bore and which with its face end contacts the valve member. It is unnecessary for the valve piston to be connected to the valve member. The first guide of the valve member, remote from the combustion chamber, now has only a guiding function and no longer serves to provide sealing. Because of the separation of the functions of sealing the pressure chamber and guiding the valve member, very good sealing of the valve piston in the bore can be achieved without creating the risk of seizing of the valve member in the bore.

The injection valve of the invention can be connected to a known valve holding body, for instance, of the kind used in so-called common rail injection systems. There is no need to adapt the valve holding body structurally.

In an advantageous feature of the subject of the invention, the contact of the valve piston with the valve member is effected by means of an essentially pointwise contact face. This advantageously makes it possible for the valve piston and valve member to shift slightly in position relative to one another because of the slight catching of the contact face. The play of the guide, remote from the combustion chamber, of the valve member is thus unhindered by the valve piston.

Further advantages and advantageous features of the subject of the invention can be learned from the drawing, description and claims.

### DRAWING

FIG. 1 shows a longitudinal section through a fuel injection valve of the invention, and

FIG. 2 is an enlarged detail of FIG. 1 in the region of the valve member.

### DESCRIPTION OF THE EXEMPLARY EMBODIMENT

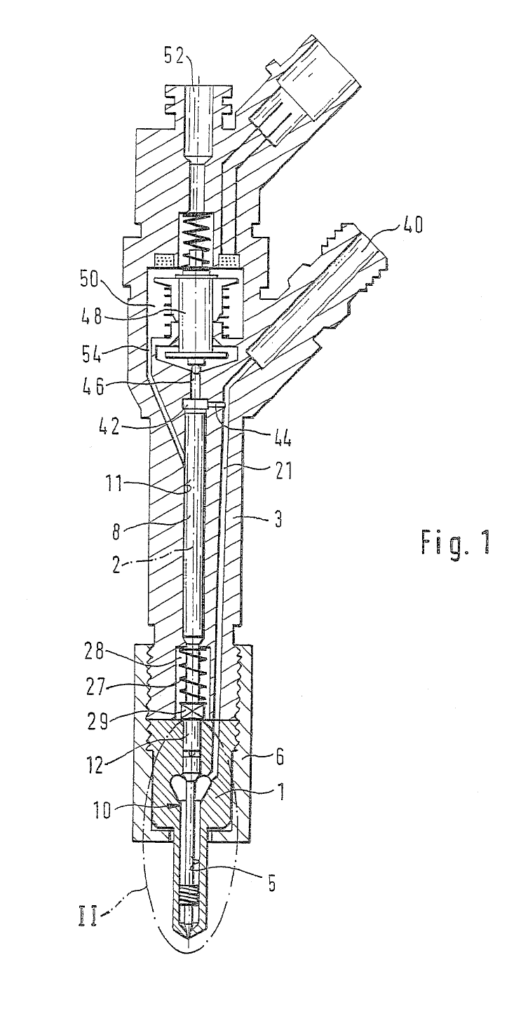

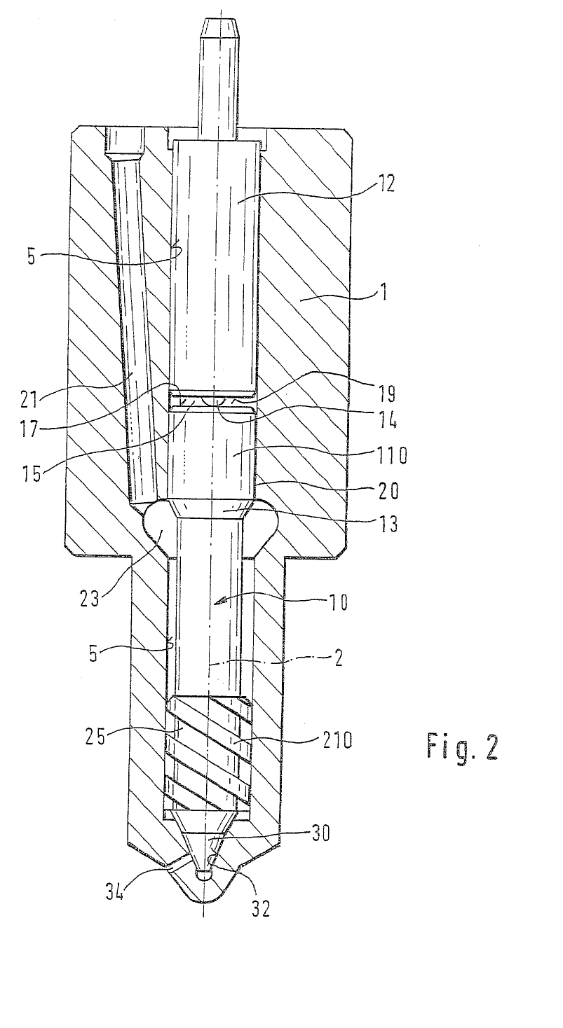

In FIG. 1, a longitudinal section is shown through a fuel injection valve that is intended for a fuel injection system on the common rail principle. The precise structure of the fuel injection valve in the region of the valve body is shown enlarged in FIG. 2. A valve body 1 is braced in the direction of a longitudinal axis 2 of the fuel injection valve against a valve holding body 3 by a lock nut 6; the end of the valve body 1 remote from the valve holding body 3 protrudes as far as the inside of the combustion chamber of an internal combustion engine, not shown in the drawing. It can also be provided that there is a shim between the valve body 1 and the valve holding body 3. A bore 5 is embodied in the valve body 1 that is closed on the end toward the combustion chamber and there forms a valve seat 32. On the end of the bore 5 toward the combustion chamber, at least one injection opening 34 is embodied as well, which connects the bore 5 to the engine combustion chamber. A pistonlike valve member 10 is disposed longitudinally displaceably in the bore 5, being disposed coaxially to the longitudinal axis 2, and a valve sealing face 30 is embodied on its end toward the combustion chamber. The valve sealing face 30 cooperates with the valve seat 32 to control the at least one injection opening 34. A pressure chamber 23 embodied by a radially widened portion of the bore 5 is disposed in the valve body 1; it continues toward the valve seat 32 in the form of an annular conduit surrounding the valve member 10 and connects the pressure chamber 23 with the injection openings 34. The pressure chamber 23 communicates, via an inlet conduit 21 extending in the valve body 1 and in the valve holding body 3, with a fuel connection 40, by way of which fuel at high pressure can be introduced into the pressure chamber 23 from a high-pressure fuel source, not shown in the drawing.

The valve member 10 has two radially widened portions 110 and 210, offset from one another axially, with which the valve member 10 is guided in the bore 5. The first radially widened portion 110 is disposed remote from the combustion chamber, toward the pressure chamber 23. The second radially widened portion 210 is disposed near the valve seat 32, so that the valve sealing face 30 is kept precisely symmetrically coaxial with the valve seat 32. Recesses in the form of oblique grooves 25 are embodied on the second radially widened portion 210, and through these grooves the fuel can flow out of the pressure chamber 23 to the injection openings 34. In the pressure chamber 23, at the transition to its first vertical widened portion 110, a pressure shoulder 13 is formed on the valve member 10.

A valve piston 12 is disposed in the bore 5, remote from the combustion chamber and toward the valve member 10; it is guided sealingly in the bore 5. The valve piston 12 is longitudinally displaceable in the bore 5 and has a lesser play in the bore 5 than the first radially widened portion 110 of the valve member 10. An integrally formed protrusion 14, which at least approximately takes the form of a spherical segment, is embodied on the face end 19 of the valve piston 12 toward the valve member 10, creating a pointwise contact of the valve piston 12 with the face end, toward it, of the valve member 10. By means of the integrally formed protrusion 14, between the valve piston 12 and the valve member 10, an interstice 15 is formed, which communicates with the pressure chamber 23 by way of the annular gap 20 formed between the first radially widened portion 110 of the valve member 10 and the bore 5.

The valve piston 12 communicates, remote from the combustion chamber, with a spring plate 29 disposed in a spring chamber 28. Between the spring plate 29 and the face end, remote from the combustion chamber, of the spring chamber 28, a spring 27 is disposed in prestressed fashion and urges the spring plate 29 toward the combustion chamber. The spring chamber 28 continues, remote from the combustion chamber, in the form of a guide bore 11, in which a longitudinally displaceable piston rod 8 is disposed that on its end toward the combustion chamber rests on the spring plate 29. With its face end remote from the combustion chamber, the piston rod 8 defines a control chamber 42, which communicates with the inlet conduit 21 via an inlet throttle 44 and with a leaking oil chamber 50 embodied in the valve holding body 3 via an outlet throttle 46 that is closable by a control element 48. The outlet throttle 46 is closable toward the leaking oil chamber 50 by an electrically triggerable control element 48. The leaking oil chamber 50 communicates with a leaking oil system, not shown in the drawing, via a leaking oil connection 52. The spring chamber 28 communicates with the leaking oil chamber 50, via the annular gap embodied between the piston 8 and the guide bore 11 and via a leaking oil conduit 54 that is embodied in the valve holding body 3, so that the fuel flowing past the valve piston 12 into the spring chamber 28 can flow out into the leaking oil chamber 50.

The radial play of the radially widened portions 110 and 210 of the valve member 10 in the bore 5 and of the valve piston 12 in the bore 5 is of different magnitudes: The second radially widened portion 210 has a very slight play, in order to assure exact guidance of the valve member 10 in the bore 5 near the valve seat 32. Correspondingly, the play of the first radially widened portion 110 in the bore 5 is made much greater, to prevent seizing of the valve member 10 or increased friction. Care must be taken that the annular gap 20 embodied between the bore 5 and the first radially widened portion 110 will always perform such pronounced throttling that no significant fuel flow occurs out of the pressure chamber 23 into the interstice during the opening phase of the valve member 10. The actual high-pressure sealing and throttling of the fuel flow out of the pressure chamber 23 into the spring chamber 28 takes place through what because of the slight play is only a very narrow annular gap between the valve piston 12 and the bore 5.

The mode of operation of the fuel injection valve is as follows: Via the high-pressure fuel system, not shown in the drawing, fuel is introduced at high pressure into the high-pressure connection 40, so that during the entire operation of the fuel injection valve, a specified fuel pressure level is maintained in the inlet conduit 21 and in the pressure chamber 23. When the fuel injection valve is closed, the control element 48 closes the outlet throttle 46, so that the same fuel pressure prevails in the control chamber 42 as in the inlet conduit 21. Since the annular gap 20 between the first radially widened portion 110 of the valve member 10 and the bore 5 is relatively large, at least approximately the same fuel pressure as in the pressure chamber 23 also prevails in the interstice 15. The diameter of the piston rod 8 is greater than the diameter of the valve piston 12, so that the hydraulic force on the face end of the piston rod 8 remote from the combustion chamber and the force of the spring 27 predominate over the hydraulic force exerted on the pressure shoulder 13 of the valve member 10. The valve piston 12 is pressed with the integrally formed protrusion 14 against the face end 17, remote from the combustion chamber, of the valve member 10 and thus presses the valve member 10 with the valve sealing face 30 against the valve seat 32. At the onset of the injection event, the outlet throttle 46 is opened by the control element 48. Via the outlet throttle 46, fuel flows out of the control chamber 42 into the leaking oil chamber 50, and the pressure in the control chamber 42 drops, since the flow resistance of the inlet throttle 44 is greater than the flow resistance of the outlet throttle 46. Because of the pressure drop in the control chamber 42, the hydraulic force on the face end of the piston rod 8 remote from the combustion chamber decreases accordingly, and the piston rod 8 is pressed away from the combustion chamber via the valve piston 12, because of the fuel pressure in the interstice 15. As a result of the motions of the valve piston 12 away from the combustion chamber, the fuel pressure in the interstice 15 immediately drops sharply, and as a result the valve member 10, because of the hydraulic force on the pressure shoulder 13 and on at least parts of the valve sealing face 30, also moves away from the combustion chamber. In this way, the valve member 10, valve piston 12 and piston rod 8 all move away from the combustion chamber, until the piston rod 8 comes into contact with the face end, remote from the combustion chamber, of the guide bore 11. Since the annular gap 20 between the first radially widened portion 110 of the valve member 10 and the bore 5 throttles the fuel flow adequately, and the entire injection event—depending on the engine rpm—lasts only a few milliseconds, only an insignificant quantity of fuel can flow into the interstice 15 via the annular gap 20 during the opening phase of the valve member 10.

The injection event is terminated by the closure of the outlet throttle 46 by the control element 48. As a result, fuel again flows through the inlet throttle 44 into the control chamber 42, and the fuel pressure in the control chamber 42 increases enough that it is equivalent to the fuel pressure in the inlet conduit 21. The hydraulic force on the end face, remote from the combustion chamber, of the piston rod 8 increases, and the piston rod 8, because of its greater diameter in comparison with the valve member 10, is moved toward the combustion chamber, until the valve member 10 with the valve sealing face 30 comes into contact with the valve seat 32 and closes the at least one injection opening 34.

In the injection event of the fuel injection valve, the spring 27 plays only a minor role and serves primarily to keep the fuel injection valve closed when the engine is off and there is accordingly a pressureless state in the inlet conduit 21.

As an alternative to the fuel injection valve shown in the drawing, it can also be provided that the recesses 25 on the second radially widened portion 210 of the valve member 10 be embodied not as oblique grooves but rather as grooves extending parallel to the longitudinal axis 36 of the valve member 10. It is furthermore also possible to assure the flow of fuel through bores that lead from the end face remote from the combustion chamber toward the end face toward the combustion chamber of the second radially widened portion 210 of the valve member 10.

It can also be advantageous to embody the bore 5 with a graduated diameter, so that the portion of the bore 5 remote from the combustion chamber, from the standpoint of the pressure chamber 23, has a greater diameter than the portion toward the combustion chamber, from the standpoint of the pressure chamber 23. The radially widened portions 110, 210 of the valve member 10 in this case have correspondingly different diameters, so that the different plays described above of the radially widened portions 110, 210 remain the same.

It is also possible to generate the closing force on the valve piston 12 not by means of the hydraulic force in a control chamber but rather by means of some other device, for instance a magnetically controlled device. The closing force on the valve piston 12 generated by this device must be capable of bringing a greater force to bear than the hydraulic force, acting in the axial direction, on the pressure shoulder 13 and on the valve sealing face 30 on the valve member 10.

The fuel injection valve described above is intended for a fuel injection system on the so-called common rail principle, in which high pressure is constantly maintained by means of a high-pressure fuel pump in a fuel reservoir, the so-called rail, and this high pressure prevails throughout operation in the inlet conduit 21 and in the pressure chamber 23. The present injection valve according to the invention can also be used, however, with valve holding bodies, in which the closing force on the valve member 10 is generated by one or more closing springs, and the injection takes place by control of the fuel pressure in the pressure chamber 23. Between injections, a lesser fuel pressure prevails in the pressure chamber 23. Because of the relatively large annular gap 20, the interstice 15 is likewise relieved and pressureless. At the onset of injection, fuel is forced into the pressure chamber 23, so that the pressure there rises. If the hydraulic force on the pressure shoulder 13 of the valve member 10 exceeds the force of the at least one closing spring, then the valve member 10 with its valve sealing face lifts away from the valve seat 32 and uncovers the injection openings 34. As already described above, the annular gap 20 throttles the fuel flow out of the pressure chamber 23 into the interstice 15 so greatly that no significant fuel flow into the interstice 15 can take place during the opening phase of the valve member 10. The end of injection is initiated by providing that no further fuel is pumped into the pressure chamber 23, and the pressure chamber is thus relieved. The valve member 10 moves toward the combustion chamber by the force of the closing spring, until with its valve sealing face 30 it contacts the valve seat 32.

The entire opening phase of the valve member 10 amounts to only a small fraction of the total length of one injection cycle. During the closed phase of the fuel injection valve, an adequate length of time is thus available within which the slight fuel quantity that has reached the interstice 15 during the opening phase can flow out, either into the pressure chamber 23 or past the valve piston 12 into the leaking oil chamber 50.

1. A fuel injection valve, having a valve body (1) that protrudes by one end into the combustion chamber of an internal combustion engine, wherein in the valve body (1), a bore (5) is embodied that is closed on the end toward the combustion chamber, where a valve seat (32) and at least one injection opening (34) are embodied, and having a pistonlike valve member (10), which is disposed longitudinally displaceably in the bore (5) and which cooperates with a sealing face (30) for controlling the at least one injection opening (34) along with the valve seat (32), wherein the valve member (10) has a first radially widened portion (110) remote from the combustion chamber and a second radially widened portion (210) toward the combustion chamber, by way of which it is guided in the bore (5), and having a pressure chamber (23), which is embodied by a radially widened portion of the bore (5) and is fillable with fuel and surrounds the valve member (10) between the first radially widened portion (110) and the second radially widened portion (210), wherein a pressure shoulder (13) is embodied on the valve member (10) in the region of the pressure chamber (23), characterized in that in the bore (5), remote from the combustion chamber, toward the valve member (10), a sealingly guided valve piston (12) is disposed, which contacts the valve member (10) and can be acted upon by a closing force in the direction of the valve seat (32).

2. The fuel injection valve of claim 1, characterized in that the first radially widened portion (110) of the valve member (10) has a greater play in the bore (5) than the second radially widened portion (210).

3. The fuel injection valve of claim 1 or 2, characterized in that the valve piston (12) has a lesser play in the bore (5) than the first radially widened portion (110) of the valve member (10).

4. The fuel injection valve of one of claims 1-3, characterized in that the closing force on the valve piston (12) is generated hydraulically.

5. The fuel injection valve of one of claims 1-4, characterized in that the contact of the valve piston (12) with the valve member (10) is embodied by means of an integrally formed protrusion (14), disposed on the valve member (10) or on the valve piston (12), by which integrally formed protrusion (14) an essentially pointwise contact of the valve member (10) with the valve piston (12) is attained.
